(19) United States
(12) Patent Application Publication
(10) Pub. No.: US 2005/0127629 A1
(43) Pub. Date: Jun. 16, 2005

(54) Skateboard Steering Assembly

(76) Inventors: Steven David Nelson, Redondo Beach, CA (US); Erik Steven Nelson, Redondo Beach, CA (US)

Correspondence Address: STEVEN D. NELSON, 1310 ESPLANADE, #311, REDONDO BEACH, CA, 90277, US

(21) Appl. No.: 10/904,810

(22) Filed: Nov. 30, 2004

Related U.S. Application Data
(60) Provisional application No. 60/481,723, filed on Nov. 30, 2003.

(51) Int. Cl. B62M 1/00

(52) U.S. Cl. 280/87.042

(57) ABSTRACT

An improved skateboard truck assembly provides very tight, small turning radius capability without the need to lift the forward truck assembly or the entire skateboard from the surface on which it is riding. Turning and riding under all conditions is stable and without wobble. Steering output is adjustable and configurable. The steering assembly uses automotive type mechanisms allowing for caster, camber, pivot and Ackerman steering adjustments.

### BACKGROUND OF INVENTION

1. Field of the Invention

This invention relates to steering devices for skateboards, roller skates, inline skates, street luges and other recreational, professional and commercial devices which use traditional truck type steering apparatus.

2. Related Art

Existing skateboards typically utilize pivoting truck assemblies as shown in U.S. Pat. No. 5,853,182, Finkle, attached to a solid wood riding deck. The truck assemblies consists of a shaft, cups, elastomeric bushings, washers, mounting plates, a single axle, bearings, two elastomeric wheels and fasteners. The skateboard rider steers the skateboard by leaning and applying pressure to opposite lateral sides of the skateboard deck which in turn causes the truck assembly to pivot and rotate the single truck axle about a single axis perpendicular to the skateboard deck. While providing a fairly rugged and reliable assembly, truck assemblies currently suffer from a number of disadvantages including:
a) the turning ability of existing skateboards is very limited due to existing truck designs. Existing truck assemblies typically consist of two wheels attached to a single axle. This arrangement allows only small axle rotation resulting in very limited skateboard turning capability. To execute tight turns, the rider must perform the awkward maneuvers of forcing the back end of the skateboard down which lifts the forward truck assembly off the surface on which it is riding and rotating the skateboard about the rear truck assembly. Less experienced skateboard riders must sometimes stop the skateboard, lift the skateboard off the ground and reposition it in its new direction. This is especially true around very tight turns. While some improvement in skateboard turning capability is possible by changing the truck's elastomeric bushing material and shaft tightness, this improvement typically has the undesirable effect of causing skateboard wobble and instability.
b) existing skateboards have no provision to adjust steering response to the amount of angle and pressure the rider applies to the deck. For every degree of deck rotation the rider applies, a fixed amount of turning radius results. If for instance a rider wants very large changes in steering radii with relatively small changes in initial deck rotation and then smaller changes in steering as more deck rotation is applied, existing skateboards cannot satisfy this need. Existing skateboards provide only a fixed, linear steering output in relation to skateboard rider input.

3. Objects and Advantages

Advantages of this invention include:
a) to provide a truck assembly which permits very tight, small turning radius capability without the need to lift the forward truck assembly or the entire skateboard from the surface on which it is riding. To provide a truck assembly which maintains stability and eliminates wobble for all truck settings and adjustments.
b) to provide a truck assembly which permits variable and adjustable steering response. Adjustability can be utilized for instance to allow small deck rotations to provide large changes in skateboard steering radii or vice verse to allow large deck rotations to make small changes in steering radii.

Further objects and advantages of this invention will become apparent from a consideration of the drawings and ensuing description.

### SUMMARY OF INVENTION

In accordance with the present invention, a skateboard steering assembly or truck is provided which has the characteristics of common automobile steering assemblies. The truck can use the automobile characteristics of steering axis inclination, caster, camber, pivot radius and Ackerman steering geometries. These characteristics provide enhanced turning and steering, stability and preferentially return to null skateboard position with no applied input forces.

The truck consists of a pivoting beam assembly attached to and rotating about a deck aligned longitudinal shaft which is attached to the skateboard deck. The pivoting of the deck by the skateboard rider rotates a cam or other linkage which forces a follower to optionally rotate a second cam which optionally forces a second follower. The first or second follower forces a tie rod to translate normal to the longitudinal shaft. A rack and pinion assembly may be used in place of the tie rod. The tie rod rotates independent wheel axle assemblies providing steering to the skateboard. The cam-follower(s) or other linkage (s) can be adjusted and replaced to provide variable output/input steering characteristics for the skateboard. Additional cam-follower(s) may be utilized in series and parallel to modify output/input characteristics. Gears or other linkages may be used in place of cams.

The truck also consists of specialized wheels which permit the axle pivot axis to be located within the wheel. This eliminates deck rotation in response to forces applied to the wheel assemblies.

### BRIEF DESCRIPTION OF DRAWINGS

FIG. 1 shows various aspects of the skateboard truck assembly with a deck attached for reference.

FIG. 2 shows various aspects of the skateboard truck assembly.

FIG. 3 shows the specialized wheel assembly.

FIG. 4 shows the follower-cam assembly.

FIG. 5 shows the tie rod assembly.

FIG. 6 shows the truck mounting block and first cam.

FIG. 7 shows the beam assembly.

FIG. 8 shows the axle assembly.

FIG. 9 shows the shaft.

FIG. 10 shows various aspects of a skateboard truck assembly which utilizes gears in place of cam-followers.

### DETAILED DESCRIPTION

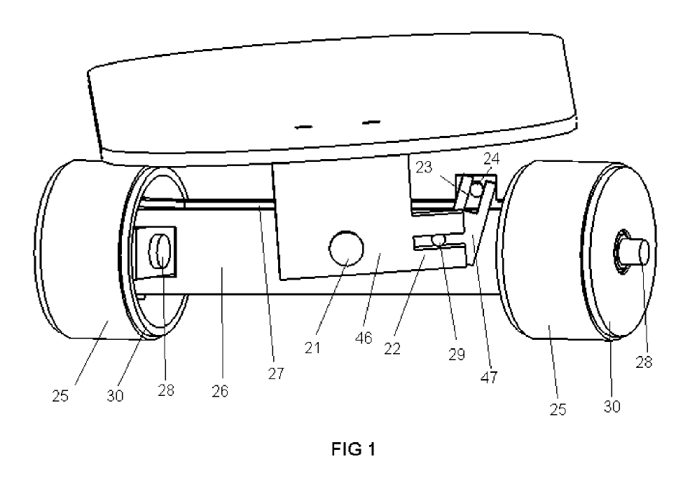

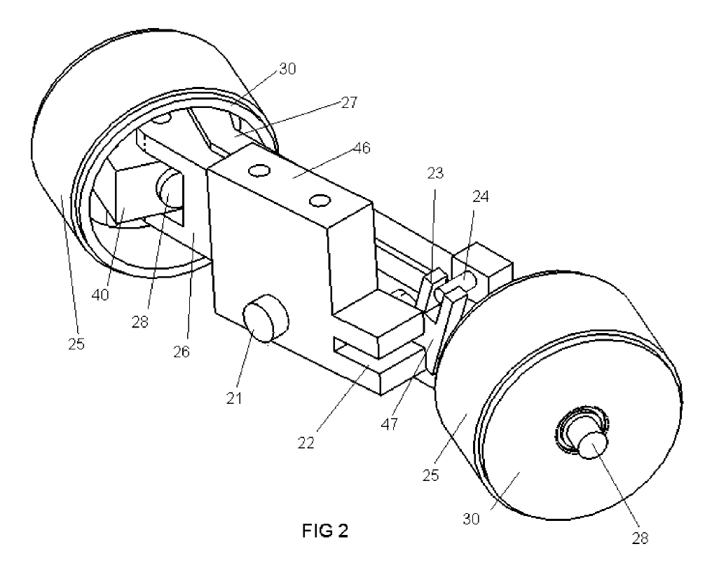

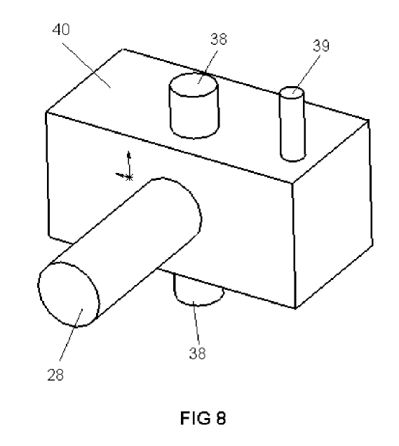

A preferred embodiment of the skateboard truck assembly of the present invention is illustrated in FIG. 1 with the skateboard deck attached and FIG. 2 perspective view with the skateboard deck not shown. The truck assembly consists of a mounting block 46, a shaft 21 and a beam 26. The mounting block and beam are attached to and allowed to rotate freely about the shaft. The skateboard rider pivots the block by applying pressure to the left side of the skateboard deck, to turn left and right to the right side of the skateboard deck to turn right. The mounting block contains a cam 22 in which a follower 29 rides. When the block is rotated in response to rider input the follower drives and rotates an optional second cam assembly 47 in which an optional second follower 24 rides. Rotation of the first or optional second cam assembly forces a translation in the first or optional second follower which is attached to a tie bar 27. The tie bar may be attached to the first cam. The tie bar translates and is attached to a drive pin FIG. 8, 39 on the left and right hand axle assemblies 40. The drive pin rotates the axle assembly about pivot bearing axes FIG. 8, 38. In addition to the drive pin the axle assemblies contain an axle 28 on which a wheel 30 rides. The rotation of the axle assembly causes the wheels to rotate about the pivot bearing axes. Because the pivot bearings are located inside the wheel assembly, forces applied to the wheel assembly as the skateboard is ridden over rough surfaces are not translated into the truck assembly. The wheel contains an elastomeric tread 25.

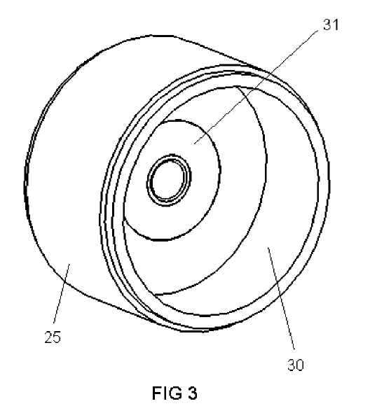

FIG. 3 illustrates the wheel assembly. The wheel assembly contains a pair of ball bearings assemblies 31, elastomeric tread 25 and wheel 30. The axle assembly FIG. 8 is located inside the wheel assembly for torque balance. Forces applied to the wheel assembly as the skateboard is ridden over rough surfaces are not translated into the truck assembly or the skateboard deck. This results in a smooth ride for the skateboarder.

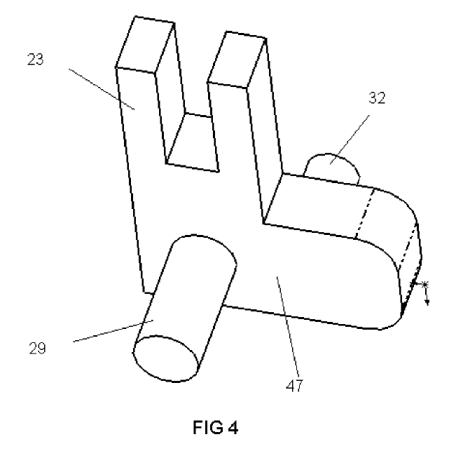

FIG. 4 depicts the first follower 29 cam 23 assembly. This assembly translates deck input rotation from the mounting block cam 22 into tie bar translation. This assembly also variably amplifies deck rotation into wheel rotation. The amplification can be used to produce very tight skateboard turning capability.

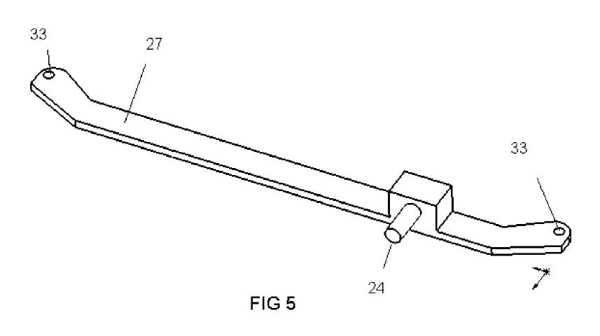

FIG. 5 illustrates the tie bar assembly. The tie bar 27 contains a cam follower 24 and two bearing holes 33 which attach to the drive pins of the axle assembly FIG. 8, 39. The tie bar translates in response to rotational inputs from the follower and drives the drive pins which rotate the axle assemblies and wheels.

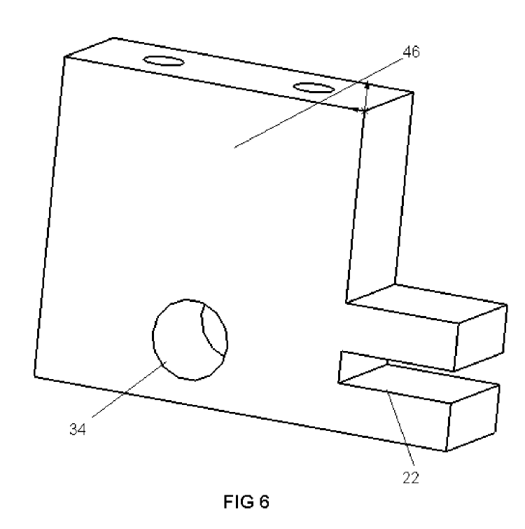

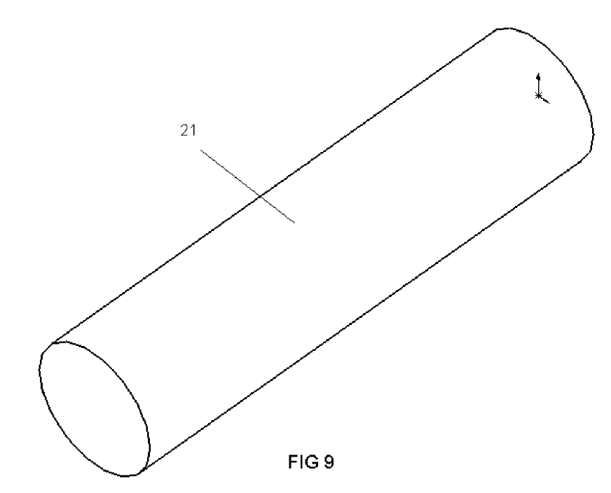

FIG. 6 depicts the truck mounting block 46 and first cam 22. The truck mounting block rigidly attaches to the skateboard deck and pivots about the shaft 21, FIG. 9. The shaft fits in the sleeve bearing 35. The truck mounting block 46 also contains the driving cam 22 which drives the follower 29 of the cam assembly 23, FIG. 4.

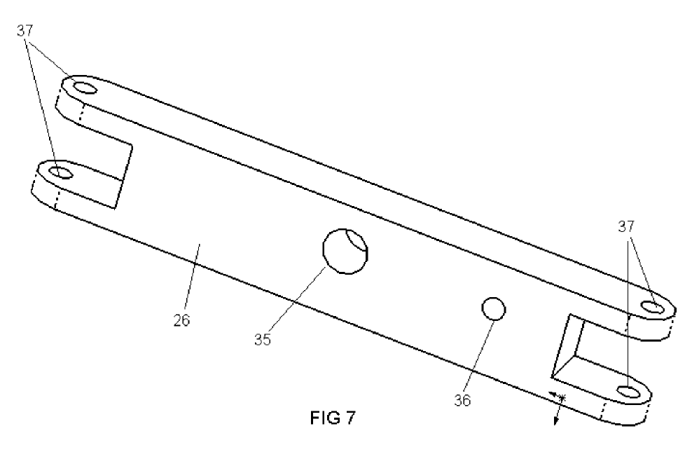

FIG. 7 depicts the beam assembly 26 on which the axle assemblies 40, FIG. 8 ride. The beam assembly contains a sleeve bearing 36 which contains and rotates around the shaft 21 as the skateboad rider rotates the deck about the shaft. The beam assembly also contains sleeve bearings 37 in which the axle assembly 40 bearing shaft 38 rotate.

FIG. 8 illustrates the axle assembly 40. The axle assembly contains a drive pin 39 which attaches to the tie bar assembly, FIG. 5. The axle assembly contains a bearing shaft which mounts in the beam assembly sleeve bearings 38, FIG. 7. The axle assembly pivots in response to tie bar translation causing the wheel axles 28 to rotate. Axle rotation causes the skateboard to turn.

FIG. 9 depicts the shaft 21. The shaft fits in the beam assembly, FIG. 7, sleeve bearing 36 and the truck mounting block, FIG. 6 sleeve bearing 35.

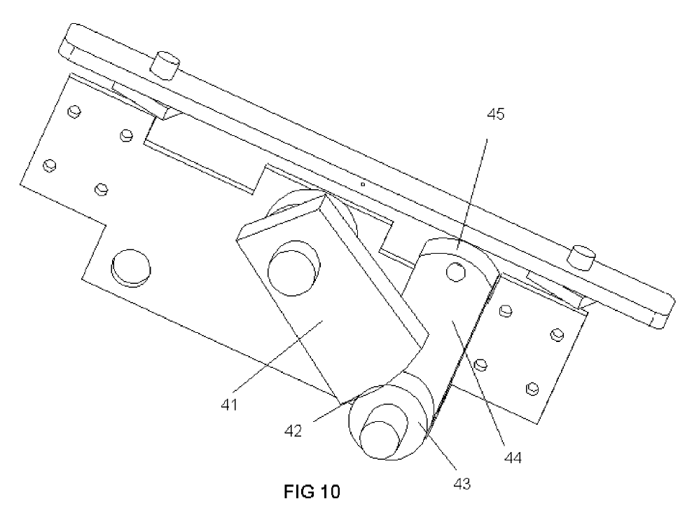

FIG. 10 illustrates an alternate approach which utilizes gears 41, 42, 43, 44, 45 in place of cams.

1. A skateboard truck comprising a plurality of wheel axles which pivot in a plane parallel to or at a small angle to the skateboard deck about independent axes perpendicular to or at a small angle to the skateboard deck whereby the rider may execute very tight turns or adjustable skateboard turning response without wobble or instability.

2. The skateboard truck assembly of claim 1 wherein said wheel axles are attached to a beam using a shaft bearing perpendicular to or at a small angle to the beam.

3. The skateboard truck assembly of claim 2 wherein said beam is attached to a mount using a shaft bearing parallel to and longitudinally along the skateboard deck.

4. The skateboard truck assembly of claim 3 wherein said mount is attached to the skateboard deck using an industry standard mounting hole pattern and fasteners.

5. The skateboard truck assembly of claim 1 wherein a drive pin is mounted normal to said axle offset from said axis.

6. The skateboard truck assembly of claim 5 wherein said drive pin is attached to a tie bar via a pivoting shaft bearing thus connecting a plurality of axles.

7. The skateboard truck assembly of claim 1 wherein said axles are attached to wheels using industry standard ball bearing assemblies.

8. The skateboard truck assembly of claim 7 wherein said wheels are hollow and have laterally offset bearing mounts allowing said axles to pivot about said axes located within the wheel assembly.

9. The skateboard truck assembly of claim 6 wherein a cam follower is attached normal to said tie bar.

10. The skateboard truck assembly of claim 6 wherein a mechanical linkage pin is attached normal to said tie bar.

11. The skateboard truck assembly of claim 6 wherein a gear rack is attached parallel to and collinear with said tie bar.

12. The skateboard truck assembly of claim 9 wherein a cam driver is attached to said mount to drive said cam follower.

13. The skateboard truck assembly of claim 10 wherein a mechanical linkage is attached to said mount to drive said pin.

14. The skateboard truck assembly of claim 11 wherein a pinion gear is attached to said mount to drive said gear rack.
